(19) United States
(12) Patent Application Publication
(10) Pub. No.: US 2025/0185054 A1
(43) Pub. Date: Jun. 5, 2025

(54) SUBBAND FULL DUPLEX (SBFD) AWARE UPLINK TRANSMISSIONS

(71) Applicant: QUALCOMM Incorporated, San Diego, CA (US)

(72) Inventors: Muhammad Sayed Khairy ABDELGHAFFAR, San Jose, CA (US); Abdelrahman Mohamed Ahmed Mohamed IBRAHIM, San Diego, CA (US); Ahmed Attia ABOTABL, San Diego, CA (US)

(21) Appl. No.: 18/525,712

(22) Filed: Nov. 30, 2023

(51) Int. Cl. H04W 72/566; H04L 5/16; H04W 72/1268

(52) U.S. Cl. CPC H04W 72/569; H04L 5/16; H04W 72/1268

(57) ABSTRACT

A wireless node may include one or more memories, individually or in combination, having instructions. The wireless node may include one or more processors, individually or in combination, configured to execute the instructions and cause the wireless node to: obtain an indication of one or more conditions associated with one or more uplink signals to be transmitted via one or more time resources that overlap with another one or more time resources associated with a downlink reference signal; and output, after obtaining the indication, uplink signaling for transmission via the one or more time resources that overlap with the other one or more time resources of the downlink reference signal.

### BACKGROUND

### Technical Field

The present disclosure generally relates to communication systems, and more particularly, to SBFD-aware wireless node uplink transmissions.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Certain aspects are directed to an apparatus for wireless communication. In some examples, the apparatus includes one or more memories, individually or in combination, having instructions. In some examples, the apparatus includes one or more processors, individually or in combination, configured to execute the instructions. In some examples, the one or more processors are configured to obtain an indication of one or more conditions associated with one or more uplink signals to be transmitted via one or more time resources that overlap with another one or more time resources associated with a downlink reference signal. In some examples, the one or more processors are configured to output, after obtaining the indication, uplink signaling for transmission via the one or more time resources that overlap with the other one or more time resources of the downlink reference signal.

Certain aspects are directed to an apparatus for wireless communication. In some examples, the apparatus includes one or more memories, individually or in combination, having instructions. In some examples, the apparatus includes one or more processors, individually or in combination, configured to execute the instructions. In some examples, the one or more processors are configured to output an indication of one or more conditions for one or more uplink signals transmitted via one or more time resources that overlap with another one or more time re-sources of a downlink reference signal. In some examples, the one or more processors are configured to obtain, after outputting the indication, an uplink signal via the one or more time resource that overlaps with the other one or more time resources associated with the downlink reference signal.

Certain aspects are directed to a method for wireless communication at a wireless node. In some examples, the method includes obtaining an indication of one or more conditions associated with one or more up-link signals to be transmitted via one or more time resources that overlap with another one or more time resources associated with a downlink reference signal. In some examples, the method includes outputting, after obtaining the indication, uplink signaling for transmission via the one or more time resources that overlap with the other one or more time resources of the downlink reference signal.

Certain aspects are directed to a method for wireless communication at a wireless node. In some examples, the method includes outputting an indication of one or more conditions for one or more uplink signals transmitted via one or more time resources that overlap with another one or more time re-sources of a downlink reference signal. In some examples, the method includes obtaining, after outputting the indication, an uplink signal via the one or more time resource that overlaps with the other one or more time resources associated with the downlink reference signal.

Certain aspects are directed to a wireless node. In some examples, the wireless node includes means for obtaining an indication of one or more conditions associated with one or more up-link signals to be transmitted via one or more time resources that overlap with another one or more time resources associated with a downlink reference signal. In some examples, the wireless node includes means for outputting, after obtaining the indication, uplink signaling for transmission via the one or more time resources that overlap with the other one or more time resources of the downlink reference signal.

Certain aspects are directed to a wireless node. In some examples, the wireless node includes means for outputting an indication of one or more conditions for one or more uplink signals transmitted via one or more time resources that overlap with another one or more time re-sources of a downlink reference signal. In some examples, the wireless node includes means for obtaining, after outputting the indication, an uplink signal via the one or more time resource that overlaps with the other one or more time resources associated with the downlink reference signal.

Certain aspects are directed to a non-transitory computer-readable medium comprising instructions that, when executed by a wireless node, cause the wireless node to perform operations. In some examples, the operations include obtaining an indication of one or more conditions associated with one or more up-link signals to be transmitted via one or more time resources that overlap with another one or more time resources associated with a downlink reference signal. In some examples, the operations include outputting, after obtaining the indication, uplink signaling for transmission via the one or more time resources that overlap with the other one or more time resources of the downlink reference signal.

Certain aspects are directed to a non-transitory computer-readable medium comprising instructions that, when executed by a wireless node, cause the wireless node to perform operations. In some examples, the operations include outputting an indication of one or more conditions for one or more uplink signals transmitted via one or more time resources that overlap with another one or more time re-sources of a downlink reference signal. In some examples, the operations include obtaining, after outputting the indication, an uplink signal via the one or more time resource that overlaps with the other one or more time resources associated with the downlink reference signal.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 is a block diagram illustrating an example subband full-duplex (SBFD) scheme according to aspects of the disclosure.

FIG. 6 is a block diagram illustrating an example SBFD scheme sharing certain characteristics with FIG. 5.

FIG. 7 is a block diagram illustrating an example SBFD scheme.

FIG. 8 is a call-flow diagram illustrating example communications between a wireless node and a network entity.

FIG. 9 is a flowchart of a method of wireless communication.

FIG. 10 is a diagram illustrating an example of a hardware implementation for an example apparatus.

FIG. 11 is a flowchart of a method of wireless communication.

FIG. 12 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In certain aspects of wireless communication, a user equipment (UE) may be configured for half-duplex communication but may also be configured as subband full duplex (SBFD) aware of the gNB SBFD operation. Such a UE may be configured to either transmit uplink communications via an uplink subband or receive downlink communications via a downlink subband in SBFD symbols at a given time. Whether the UE will transmit or receive at the given time may be controlled by whether a base station or other network entity is transmitting a synchronization signal block (SSB) at that time. For example, even if the UE is scheduled to transmit an uplink signal at a particular time, the UE may forego the uplink transmission if it would overlap in time with an SSB downlink transmission. As such, the UE prioritizes receiving an SSB which improves SSB detection and measurement at the UE. However, prioritizing the SSB may degrade uplink performance due to reduced uplink transmission opportunities.

Accordingly, aspects of the disclosure are directed to SBFD-aware UEs that may be configured to prioritize one of receiving an SSB downlink transmission or transmitting an uplink signal at a given time. As such, the UE may be configured or indicated to prioritize either receiving the SSB downlink signal or transmitting the uplink signal based on one or more network configured parameters. For example, the network may configure the UE to ignore an SSB reception and instead transmit an uplink signal at a given time based on priority. For example, the network may configure the UE to prioritize certain uplink transmissions, and to transmit those prioritized uplink transmissions even if the uplink time resources overlap with an SSB. In one example, the network may configure the UE to prioritize physical uplink shared channel (PUSCH) transmissions but not prioritize physical uplink control channel (PUCCH) transmissions. In this example, the UE may transmit PUSCH using time resources that overlap with SSB (thereby ignoring the SSB) but will skip transmission of PUCCH in favor of receiving an SSB if the scheduled PUCCH overlaps with the SSB.

In certain aspects, the network may configure the UE to ignore an SSB reception and instead transmit an uplink signal at a given time based on scheduling. For example, the network may configure the UE to prioritize uplink transmissions based on whether the uplink transmission was scheduled via downlink control information (DCI) or radio resource control (RRC) messaging. For example, if an uplink transmission is scheduled via RRC, then the UE may refrain from transmitting the uplink signaling if the uplink transmission resources overlap with an SSB. However, if an uplink transmission is scheduled via DCI, then the UE may transmit the uplink signaling even if the uplink transmission resources overlap with an SSB.

In certain aspects, the network may configure the UE to ignore an SSB transmission and instead transmit an uplink signal at a given time based on an SSB configuration. For example, the network may configure the UE to prioritize uplink transmissions over certain types of SSBs. Wireless communications may use different types of SSBs, such as cell defined SSBs (CD-SSBs), non-cell defining SSBs (NCD-SSBs), measurement timing configuration SSBs (MTC-SSBs), SSBs for layer 1 (L1) beam management and reporting, SSBs for radio link management (RLM) measurements (e.g., BFD-RS, RLM-RS), SSBs for radio resource management (RRM) measurements, and any other SSB and/or reference signal types. In the previously mentioned example, the network may configure the UE to ignore certain type(s) of SSBs in favor of transmitting an uplink communication if the uplink resources overlap in time with the certain type(s) of SSBs. Similarly, the network may configure the UE to cancel an uplink transmission in favor of receiving other type(s) of SSBs if the uplink transmission overlaps in time with the other type(s) of SSBs.

Accordingly, the network may control whether and how often the UE ignores an SSB in favor of an uplink transmission scheduled for a time that overlaps with the SSB in at least one symbol. As such, the network may reduce any negative impacts on SSB detection and measurement by the UE if uplink transmissions are favored too heavily, and may reduce uplink performance degradation if too many uplink opportunities are skipped in favor of receiving an SSB.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

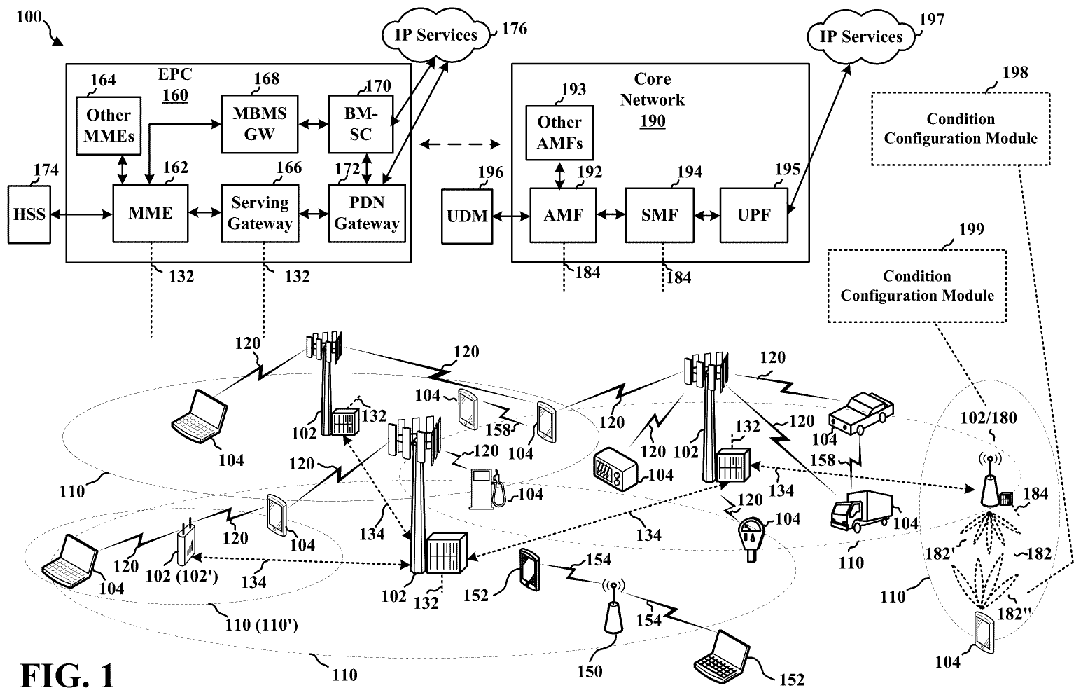

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (Pcell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a UE, a base station, or a network entity of the base station.

Referring again to FIG. 1, the UE 104 may include a condition configuration module 198. As described in more detail elsewhere herein, the condition configuration module 198 may be configured to obtain an indication of one or more conditions associated with one or more uplink signals to be transmitted via one or more time resources that overlap with another one or more time resources associated with a downlink reference signal; and output, after obtaining the indication, uplink signaling for transmission via the one or more time resources that overlap with the other one or more time resources of the downlink reference signal. Additionally, or alternatively, the condition configuration module 198 may perform one or more other operations described herein.

The base station 102/180 may include a condition configuration module 199. As described in more detail elsewhere herein, the condition configuration module 199 may be configured to output an indication of one or more conditions for one or more uplink signals transmitted via one or more time resources that overlap with another one or more time resources of a downlink reference signal; and obtain, after outputting the indication, an uplink signal via the one or more time resource that overlaps with the other one or more time resources associated with the downlink reference signal. Additionally, or alternatively, the condition configuration module 199 may perform one or more other operations described herein.

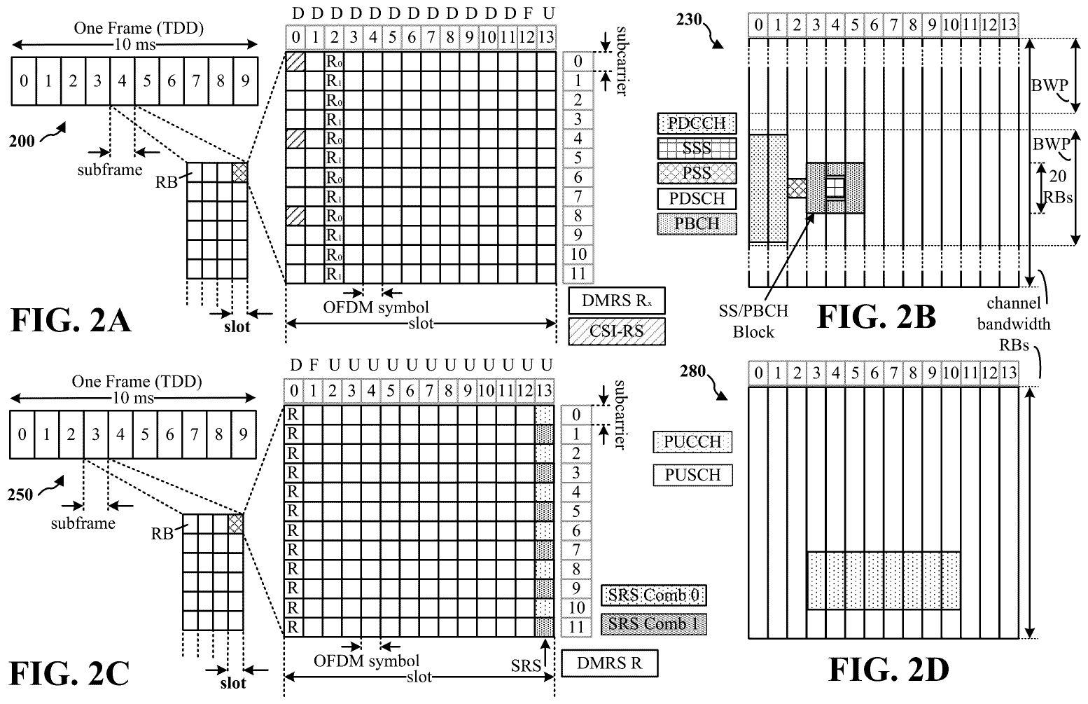

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 24 slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

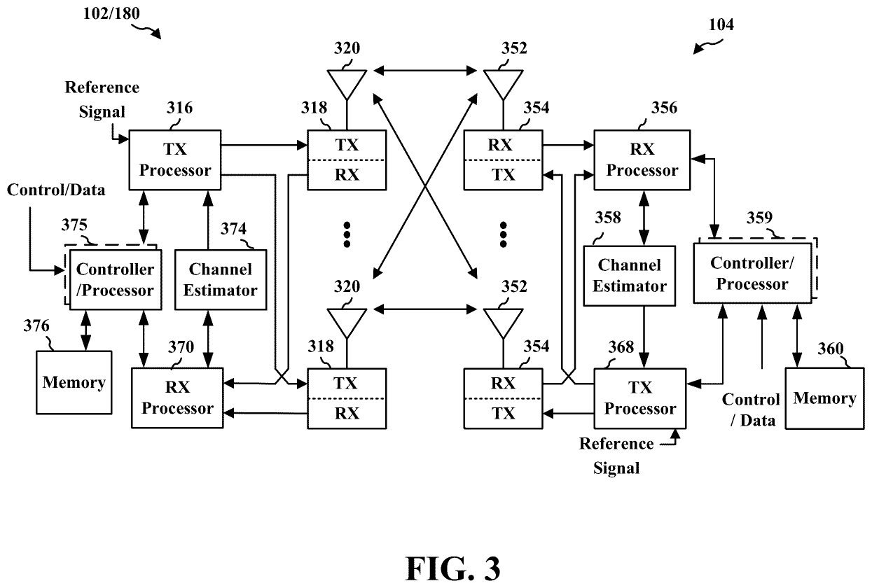

FIG. 3 is a block diagram of a base station 102/180 in communication with a UE 104 in an access network. In the DL, IP packets from the EPC 160 may be provided to one or more controller/processors 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller(s)/processor(s) 359 may be configured to perform aspects in connection with 198 of FIG. 1.

At least one of the TX processor 316, the RX processor 370, and the controller(s)/processor(s) 375 may be configured to perform aspects in connection with 198 of FIG. 1.

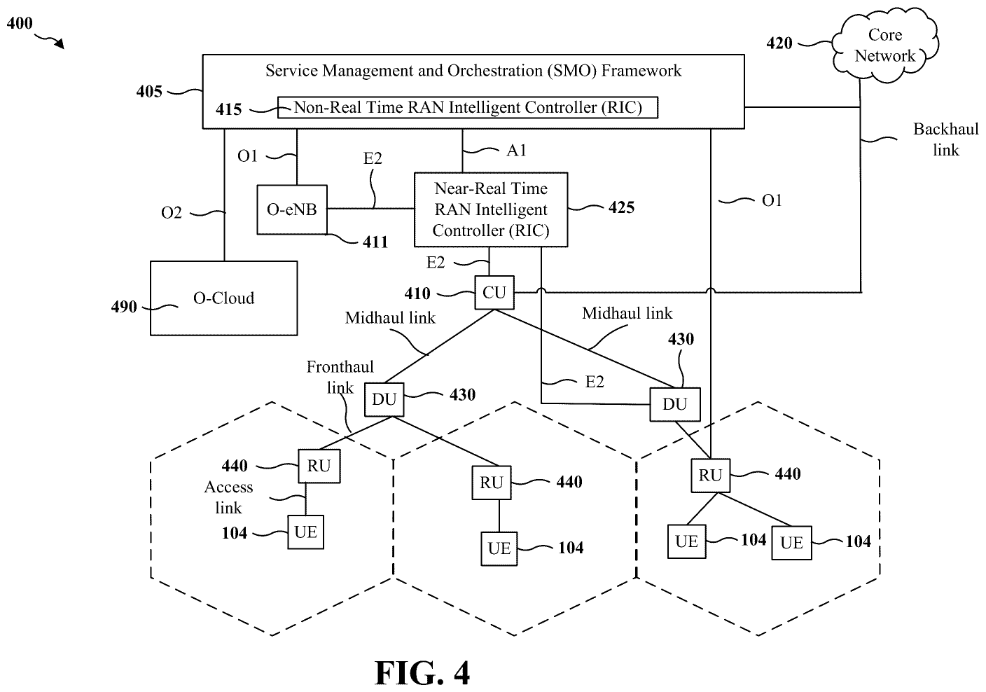

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/RU, etc.) of the base station.

Each of the units, i.e., the CUS 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control plane functionality (i.e., central unit-control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via 01) or via creation of RAN management policies (such as A1 policies).

### Example of a Sub-Band Full Duplex (SBFD) Communication Scheme

The simultaneous use of the same set of frequency resources (e.g., same carrier bandwidth, same frequency band) for both uplink and downlink in a given time slot may be referred to herein as sub-band full duplex (SBFD), also referred to as flexible duplex, in which transmissions in different directions are carried in different sub-bands or bandwidth parts (BWPs) of a carrier bandwidth or frequency band. Wireless nodes (e.g., UEs or other wireless communication devices) that are able to operate in a full-duplex mode may be able to use SBFD to increase the amount of data transferred in comparison to TDD because, as with FDD, data may be transmitted and received at the same time, while in contrast to FDD, the data may be transmitted and received in the same carrier bandwidth or frequency band.

As used herein, the term “duplex mode” refers to an operational mode of a device (e.g., a UE) or network entity (e.g., a base station). Examples of duplex modes may include but are not limited to half-duplex, full-duplex capable, and full-duplex-aware (FD-aware) or SBFD-aware. In a half-duplex operational mode, the device may have two-way communications (e.g., uplink and downlink), but the half-duplex two-way communications do not occur simultaneously. Time division duplex (TDD) is an example of a half-duplex system. In a full-duplex operational mode, the device may have two-way communications, and the full-duplex communications may occur simultaneously. Two types of full-duplex communication systems are provided as non-limiting examples herein; broadly, they may be referred to as paired spectrum and unpaired spectrum full-duplex communication schemes. FDD is an example of a full-duplex paired spectrum scheme (where uplink and downlink may occur at the same time in different but paired, pre-defined frequency bands). SBFD is a non-limiting example of a full-duplex unpaired spectrum scheme (where uplink and downlink may occur at the same time in the same frequency band/carrier bandwidth).

In an FD-aware or SBFD-aware operational mode, the device may be aware that time-frequency resources may be allocated according to any type of full-duplex communication system; however, the device is not configured as a full-duplex device (e.g., the device is only a half-duplex device). Examples described herein may be explained in the context of SBFD-aware wireless nodes operating within an SBFD communication scheme; however, the use of SBFD communication schemes is exemplary and non-limiting. Other types of unpaired spectrum full-duplex communication systems are within the scope of the disclosure.

Network entities (e.g., base stations or other RAN nodes) that support SBFD can provide improved use of bandwidth for wireless nodes that are SBFD capable or SBFD-aware. A network entity may configure a time slot (including a set of OFDM symbols) for SBFD by configuring a frequency resource (e.g., use of one new radio (NR) operating band radio channel currently designated for TDD half-duplex operation) for both transmission and reception.

However, not all wireless nodes can communicate using an SBFD scheme. For example, some wireless nodes may have an inexpensive front end that includes a switch that couples an antenna to either the wireless nodes receiver or the wireless nodes transmitter, depending on the state of the switch. Thus, such non-SBFD wireless nodes may be configured for either transmission or reception, but not both at the same time. Examples of non-SBFD wireless nodes include half-duplex (HD) wireless nodes and SBFD-aware wireless nodes.

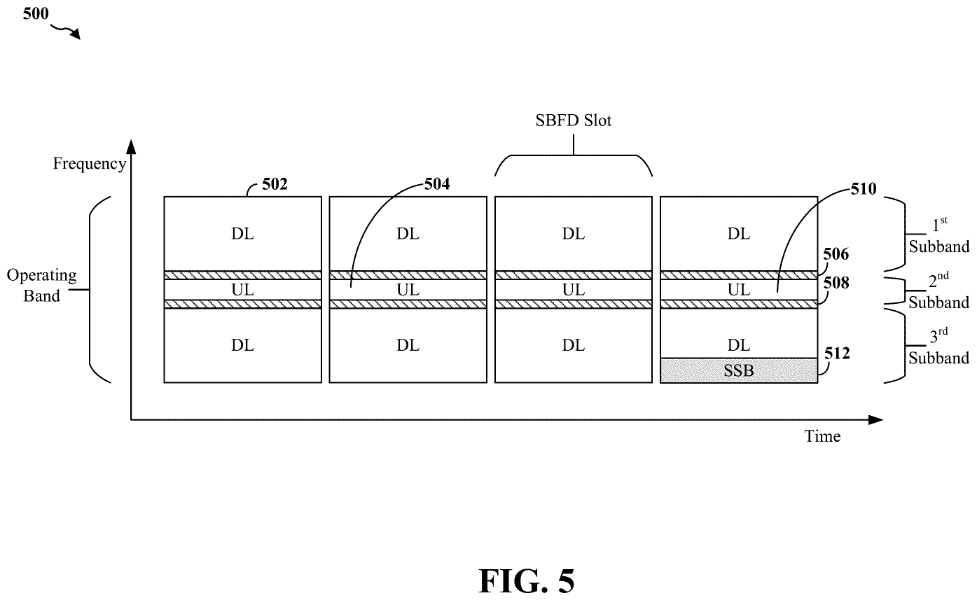

FIG. 5 is a block diagram illustrating an example SBFD scheme 500 according to aspects of the disclosure. In this example, time is illustrated along a horizontal axis, while frequency is illustrated along a vertical axis. Here, a full-duplex network may utilize SBFD in an unpaired spectrum, in which transmissions in different directions are carried in different sub-bands or BWPs of the carrier bandwidth (e.g., of a frequency band). As illustrated, the example SBFD scheme 500 includes four contiguous SBFD slots, a 1^{st} subband and a 3^{rd} subband for downlink transmissions, and a 2^{nd} subband for uplink transmissions. It should be noted that any suitable subband configuration may be used, including SBFD schemes with more or fewer subbands.

A plurality of downlink channels 502 (e.g., PDSCH and/or PDCCH) and a plurality of uplink channels 504 (e.g., PUSCH and/or PUCCH) are all depicted as occupying a single operating band. The single operating band is utilized for uplink and downlink without separating the uplink and downlink information in time (e.g., uplink and downlink resources occupy the same time slots simultaneously). A first guard band 506 and a second guard band 508 are depicted in FIG. 5. The first guard band 506 and the second guard band 508 may be the same bandwidth or different bandwidths. Either or both of the first guard band 506 and the second guard band 508 may be zero bandwidth guard bands.

Here, an SBFD-aware wireless node configured for half-duplex communication may receive downlink signals via the downlink channels 502 and may transmit uplink signals via the uplink channels 504 but may not do both at the same time. Moreover, current standards may restrict uplink transmission opportunities of SBFD-aware wireless nodes in certain scenarios. For example, as illustrated in FIG. 5, a wireless node may forego a scheduled uplink opportunity 510 in an SBFD slot that contains a reference signal, such as an SSB transmission 512. Here, because the scheduled uplink opportunity 510 overlaps in time with at least one symbol of the SSB transmission 512, the SBFD-aware wireless node may receive the SSB transmission 512 instead of transmitting uplink signaling via the uplink opportunity 510. As such, SBFD-aware wireless nodes may forego uplink transmissions (e.g., PUSCH and PUCCH transmissions, including SPS HARQ ACK transmissions), which may result in segmentation of uplink transmissions, deferred uplink transmissions, or missed uplink transmissions.

### Examples of Uplink Transmissions Having RS-Overlapping Time Resources

Accordingly, in some examples, an SBFD-aware wireless node may not treat an SBFD slot containing reference signal (RS) symbols as an available slot for transmitting uplink signal repetitions. For example, a network entity may transmit a grant to an SBFD-aware wireless node indicating a number of repetitions for transmitting an uplink signal (PUSCH and/or PUCCH). If one of the repetitions of the uplink signal occurs in an SBFD slot containing RS symbols (e.g., as indicated by ssb-PositionsInBurst), then the UE may refrain from transmitting the uplink signal in that slot and instead receive the RS signal. The UE may defer transmission of the uplink signal until the next available uplink transmission opportunity.

When uplink repetitions are scheduled by a network entity, they can be configured as type A or type B. Type A is configured as slot-based repetitions, where the same time domain allocation can be used in repeated slots, in particular the starting symbol, duration of PUSCH, and PUSCH mapping type in each slot in an aggregation are the same and derived from the time domain resource allocation field of a DCI scheduling PUSCH or activating Type 2 CG-PUSCH. Type B is configured as back-to-back repetitions (e.g., consecutive mini-slots), where the starting symbol of repetitions other than the initial one is derived based on an ending symbol of the previous repetition or based on another rule/indication so that the uplink signal repetitions can even be performed within one slot or with minimum/no gap in different slots.

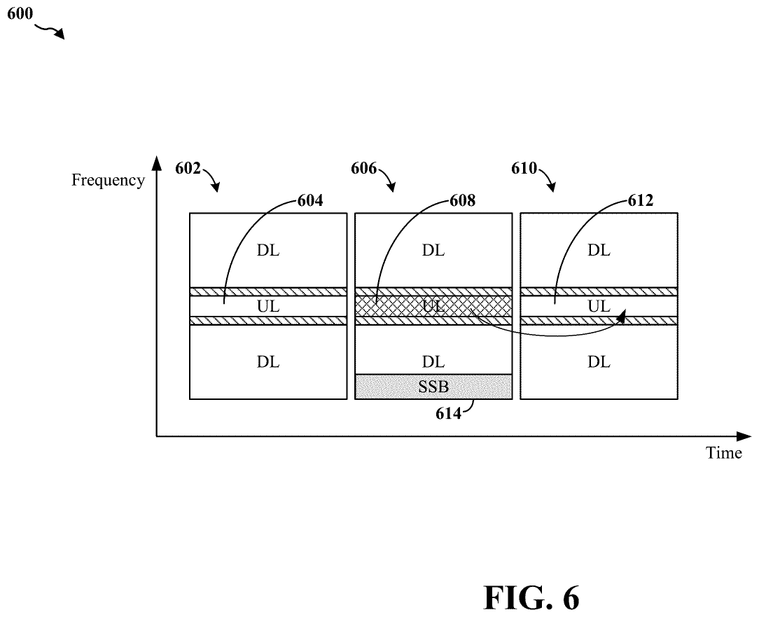

FIG. 6 is a block diagram illustrating an example SBFD scheme 600 sharing certain characteristics with FIG. 5. For example, the SBFD scheme 600 includes three contiguous SBFD slots, a 1^{st} subband and a 3^{rd} subband for downlink transmissions, and a 2^{nd} subband for uplink transmissions.

Here, a network entity may schedule an SBFD-aware wireless node for type A uplink repetitions, with an initial uplink transmission 604 scheduled at a first SBFD slot 602 and a first uplink repetition 608 scheduled at a second SBFD slot 606. However, in this example, the first uplink repetition 608 is scheduled using uplink resources that overlap in time with a downlink RS transmission 614. Accordingly, the wireless node may drop or cancel the first uplink repetition 608 at the second SBFD slot 606 in order to receive the RS transmission 614. In other words, the wireless node may refrain from transmitting an uplink signal at the second SBFD slot 606. As such, the second SBFD slot 606 is not counted toward the scheduled uplink repetitions.

Thus, the wireless node may defer transmission of the first uplink repetition 608 for a next available slot 610 (e.g., a slot having uplink resources that do not overlap in time with RS resources). Accordingly, at the next available slot 610, the wireless node may transmit the deferred uplink repetition 612. It should be noted that although the example of FIG. 6 describes an uplink schedule of one uplink transmission repetition, any suitable number of repetitions may be used. Moreover, although FIG. 6 illustrates three contiguous SBFD slots, uplink signaling may be deferred any suitable number of slots, and the slots may be of any suitable format including uplink, flexible, and/or downlink.

However, in certain aspects, if the wireless node cancels the first uplink repetition 608 and transmits the deferred uplink repetition 612, uplink communication efficiency may be negatively impacted. Thus, in some examples, a network entity may configure the wireless node with conditions that, if met, allow the wireless node to ignore the RS transmission 614 in favor of transmitting the first uplink repetition 608. As such, if the conditions are met, then the wireless node may not be required to transmit the deferred uplink repetition 612.

Thus, if an SBFD-aware wireless node is scheduled with uplink message repetition, and at least one symbol of an uplink transmission repetition opportunity overlaps with a symbol of an RS transmission, and at least one condition set by the network entity is met, then the wireless node may transmit the uplink repetition (e.g., prioritize the uplink repetition over RS reception) in the uplink transmission repetition opportunity despite the opportunity overlapping with a symbol of the RS transmission. Accordingly, the uplink transmission repetition opportunity is considered an available slot for uplink transmission and is counted towards the number of scheduled repetitions. However, if the condition is not met, then the wireless node may prioritize reception of the RS transmission and defer transmission of the uplink repetition for a future uplink opportunity (as illustrated in FIG. 6).

It should be noted that although the above describes an example of type A uplink repetition, the wireless node may be configured to defer any other uplink transmissions, whether on a slot or symbol basis, when those transmissions overlap in time with an RS signal. For example, the wireless node may defer transmission of a HARQ ACK of a configured DL transmission (e.g., semi-persistent scheduled (SPS) PDSCH) from a scheduled uplink opportunity to a future uplink opportunity if the scheduled opportunity overlap in time with an RS signal. However, similar to the above, the wireless node may be configured with conditions that, if met, allow the wireless node to ignore the RS signal in favor of transmitting the uplink a HARQ ACK using the scheduled uplink opportunity instead of deferring the HARQ ACK.

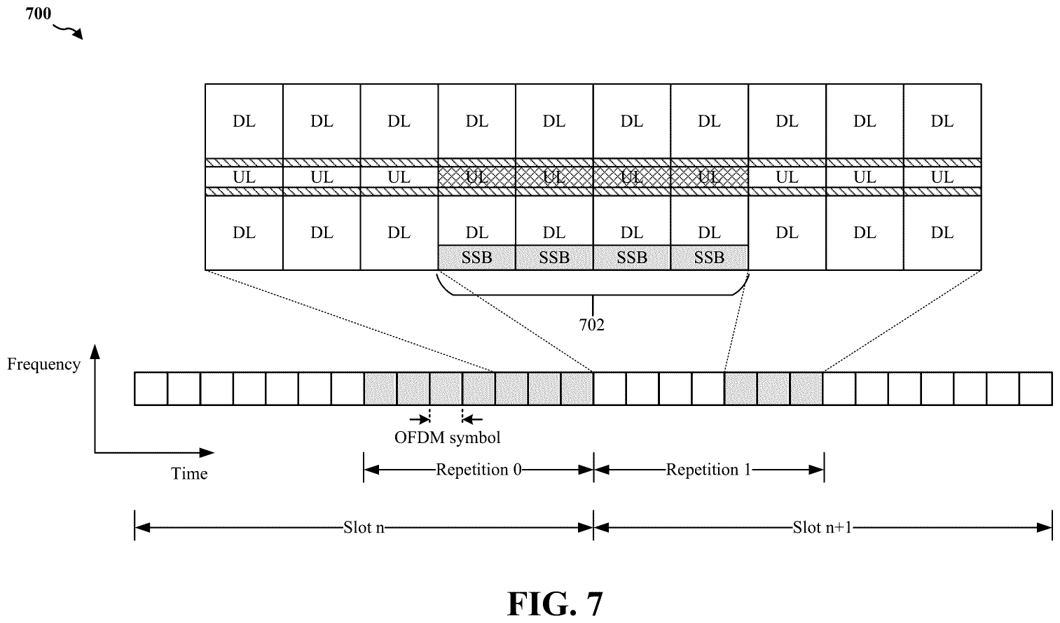

FIG. 7 is a block diagram illustrating an example SBFD scheme 700. The SBFD scheme 700 includes two contiguous SBFD slots (slot n and slot n+1), wherein each slot is an SBFD slot including 14 SBFD symbols. Here, a network entity may schedule an SBFD-aware wireless node for type B uplink repetitions, with a first uplink repetition (nominal repetition 0) scheduled at the last seven symbols of slot n, and a second uplink repetition (nominal repetition 1) scheduled at a first seven symbols of slot n+1. However, in this example, the first four symbols of the second uplink repetition overlap in time with a downlink RS transmission 702. Accordingly, the wireless node may segment the second uplink repetition and drop or cancel the first four symbols of the second uplink repetition in order to receive the RS transmission 702. In other words, the wireless node may refrain from transmitting an uplink signal at the first four symbols of the second uplink repetition. As such, second uplink repetition may be segmented such that second uplink repetition is composed of only three symbols.

However, in certain aspects, segmenting the second uplink repetition may negatively affect uplink communication efficiency. Thus, in some examples, a network entity may configure the wireless node with conditions that, if met, allow the wireless node to ignore the RS transmission 702 in favor of transmitting all seven symbols of the second uplink repetition of slot n+1. As such, if the conditions are met, then the wireless node may not be required to segment the second uplink repetition.

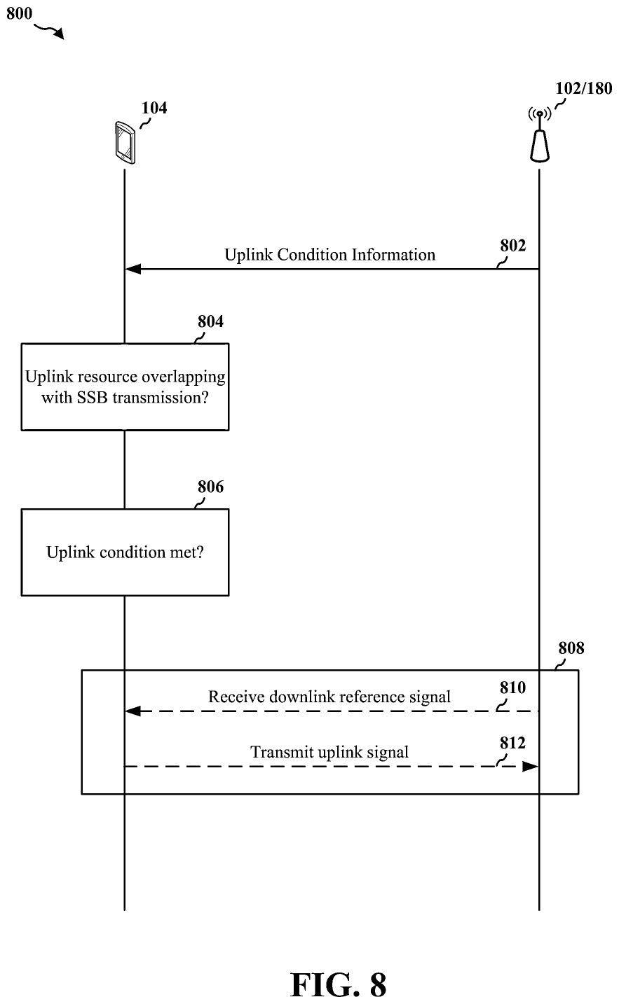

FIG. 8 is a call-flow diagram illustrating example communications 800 between a wireless node (e.g., UE 104 of FIG. 1) and a network entity (e.g., base station 102 of FIG. 1). The UE 104 may be an SBFD-aware UE and configured to defer or refrain from transmitting an uplink signal via an uplink resource that overlaps in time with a downlink resource used to transmit a reference signal (e.g., an SSB). For example, the UE may defer transmission of an uplink signal or segment a transmitted uplink signal, as described above in connection with FIGS. 6 and 7.

Initially, the base station 102 may transmit a first communication 802 that includes an indication of one or more conditions for uplink signals transmitted via time resources that overlap with a downlink reference signal such as an SSB signal. That is, the conditions may indicate scenarios where the UE 104 may prioritize transmission of an uplink signal via uplink resources and ignore an RS signal that overlaps in time with the uplink resources. Thus, if one or more conditions are satisfied, the UE 104 may prioritize transmission of an uplink signal over receiving an RS signal.

In some examples, the conditions for uplink signals may include one or more of a network scheduling condition, a configuration condition, a scheduling condition, or a priority condition. In certain aspects, the network scheduling condition may relate to whether the uplink signaling is scheduled by a network via a downlink control information (DCI) message or a radio resource control (RRC) message. For example, the base station 102 may schedule the UE 104 for an uplink transmission (e.g., type A, type B, SPS HARQ ACK, CORESET for type 0 PSCCH common search space (CSS), etc.) via cither DCI or RRC. Here, the means by which the UE 104 was scheduled (e.g., DCI or RRC) may be the condition that allows the UE 104 to prioritize transmission of an uplink signal via uplink resources and ignore an RS signal that overlaps in time with the uplink resources. Thus, for example, the base station 102 may configure the UE 104 to prioritize an uplink transmission if the uplink transmission is scheduled via DCI, and prioritize receiving an RS downlink signal if the uplink transmission is scheduled via RRC. Accordingly, if the uplink transmission is scheduled via DCI and the corresponding uplink resources overlap in time with an RS, then the UE 104 may ignore the RS and transmit the uplink signaling via the uplink resources. On the other hand, if the uplink transmission is scheduled via RRC and the corresponding uplink resources overlap in time with an RS, then the UE 104 may refrain from transmitting the uplink signal, and instead defer transmission of the uplink signal (e.g., as described in reference to FIG. 6) or segment the uplink signal (e.g., as described in reference to FIG. 7).

Although the above describes an example network scheduling condition in terms of RRC and DCI, the network may use any suitable scheduling aspect to set conditions for when the UE 104 may transmit an uplink signal using uplink resources that overlap at least in part with an RS signal.

In certain aspects, the configuration condition is indicative of whether the downlink reference signal is a low priority type or a high priority type. Here, the network may set one or more types of reference signals and SSB signals as either a high priority or low priority. For example, different types of reference signals and SSB signals may include a cell defining SSB (CD-SSB), a non-cell defining SSB (NCD-SSB), SSB-MTC (e.g., as provided by SSB-MTC-AdditionalPCI), SSBs for layer 1 (L1) beam management and reporting, SSBs for RLM measurement (e.g., beam failure detection (BFD-RS), radio link monitoring (RLM-RS), etc.), SSBs for radio resource management (e.g., synchronization signal block measurement timing configuration (SMTC)), etc. Here, if the indication of conditions indicates that certain types of reference signals and/or SSBs are “low priority,” and the UE 104 is scheduled to transmit an uplink signal using uplink resources that overlap in time with a low priority reference signal or SSB, then the UE 104 may ignore the low priority reference signal or SSB and instead transmit the uplink signal using the overlapping uplink resources. However, if the UE 104 is scheduled to transmit an uplink signal using uplink resources that overlap in time with a “high priority” reference signal or SSB, then the UE 104 may defer transmission of the uplink signal or segment the uplink signal in order to receive the high priority reference signal or SSB.

Although the above describes an example configuration conditions in terms of SSB and/or reference signal types, the network may use any suitable downlink signal configuration aspect to set conditions for when the UE 104 may transmit an uplink signal using uplink resources that overlap at least in part with an SSB signal or other reference signal.

In certain aspects, the priority condition is indicative of whether the uplink signaling is a low priority type or a high priority type. Here, the network may set one or more types of uplink signaling as either high priority or low priority. For example, different types of uplink signaling may include PUSCH signaling and PUCCH signaling. In this example, if the indication of conditions indicates that PUCCH signaling is “low priority,” and the UE 104 is scheduled to transmit PUCCH signaling using uplink resources that overlap in time with a downlink reference signal or SSB, then the UE 104 may defer or segment the PUCCH signaling in order to receive the downlink reference signal or SSB. However, if the indication of conditions indicates that PUSCH signaling is “high priority,” and the UE 104 is scheduled to transmit PUSCH signaling using uplink resources that overlap in time with a downlink reference signal or SSB, then the UE 104 may ignore the downlink SSB or reference signal and proceed to transmit the PUSCH signaling.

Although the above describes an example priority conditions in terms of uplink channel types, the network may use any suitable aspect of an uplink signal and/or channel configuration to set conditions for when the UE 104 may transmit an uplink signal using uplink resources that overlap at least in part with an SSB signal or other reference signal.

At a first process 804, the UE 104 may determine whether an uplink resource to be used for an uplink transmission overlaps in time with a downlink resource used for transmission of a reference signal (e.g., SSB). For example, the base station 102 may schedule the UE 104 with uplink message repetition (e.g., type A PUSCH, PUCCH, SPS HARQ ACK, etc.) where each uplink transmission occasion occurs in a slot, and the UE 104 may determine whether at least one symbol of at least one of the uplink transmission occasions overlaps with a symbol used for transmission of a downlink reference signal (e.g., as provided by ssb-PositionsInBurst).

In another example, the base station 102 may schedule the UE 104 with uplink message repetition (e.g., type B PUSCH) where each uplink transmission occasion occurs in fewer than 14-symbols (e.g., mini-slot), and the UE 104 may determine whether at least one symbol of at least one of the uplink transmission occasions overlaps with a symbol used for transmission of the downlink reference signal.

In yet another example, the UE 104 may determine whether at least one symbol of a PUCCH resource carrying an SPS HARQ ACK uplink transmission overlaps with a symbol used for transmission of the downlink reference signal, or whether at least one symbol of a CORESET for type 0 PDCCH common search space (CSS) overlaps with the symbol used for transmission of the downlink reference signal.

At a second process 806, the UE 104 may determine whether at least one of the one or more conditions for indicated by the first communication 802 is met. If any of the conditions are met, then the UE 104 may transmit an uplink signal via time resources that overlap with a downlink reference signal. In other words, if the conditions are met, then the symbol(s) and/or slot(s) that overlap in time with the downlink reference signal are considered a valid symbol pattern and/or an available slot for uplink transmission. If none of the one or more conditions are met, then the UE may defer transmission of an uplink signal or segment (e.g., refrain from transmitting the uplink signal via uplink symbols that overlap in time with the downlink reference signal) the uplink signal.

For example, referring to FIG. 6, if at least one of the one or more conditions are met, then the UE 104 may consider the second SBFD slot 606 as a valid and available slot for transmission of the first uplink repetition 608 despite the uplink resources of the second SBFD slot 606 overlapping in time with RS resources (e.g., RS transmission 614). Thus, transmitting the first uplink repetition 608 at the second SBFD slot 606 counts toward the number of repetitions of that uplink signal. However, if at least one of the one or more conditions are not met, then the UE 104 may defer transmission of the first uplink repetition 608 until the next available slot (e.g., the next available slot 610 or another slot thereafter). Accordingly, the UE 104 may receive the downlink reference signal at the second SBFD slot 606 instead of transmitting an uplink signal.

Similarly, if at least one of the one or more conditions are met, then the UE 104 may consider a first SBFD slot as a valid and available slot for transmission of SPS HARQ-ACK or CORESET for type 0 PDCCH CSS despite the first slot overlapping in the time domain with an SBFD symbol used for transmission of a downlink reference signal. However, if at least one of the one or more conditions are not met, then the UE 104 may defer transmission of the SPS HARQ-ACK or CORESET for type 0 PDCCH CSS until the next available slot or symbol.

Referring now to FIG. 7, if at least one of the one or more conditions are met, then the UE 104 may transmit a complete symbol pattern (e.g., without segmenting the symbol pattern of one of the repetitions) of the type B uplink signal despite the uplink resources of four SBFD symbols overlapping in time with the downlink reference signal (e.g., downlink RS transmission 702). However, if at least one of the one or more conditions are not met, then the UE 104 may segment the symbol pattern of repetition 0 and/or repetition 1 by refraining from transmitting an uplink signal using symbols that overlap in time with a downlink reference signal. Accordingly, the UE 104 may receive the downlink reference signal instead of transmitting an uplink signal.

At a second communication 808, the UE may either receive 810 the downlink reference signal transmitted by the base station 102, or transmit 812 the uplink signal, depending on whether at least one of the one or more conditions are met, as described above.

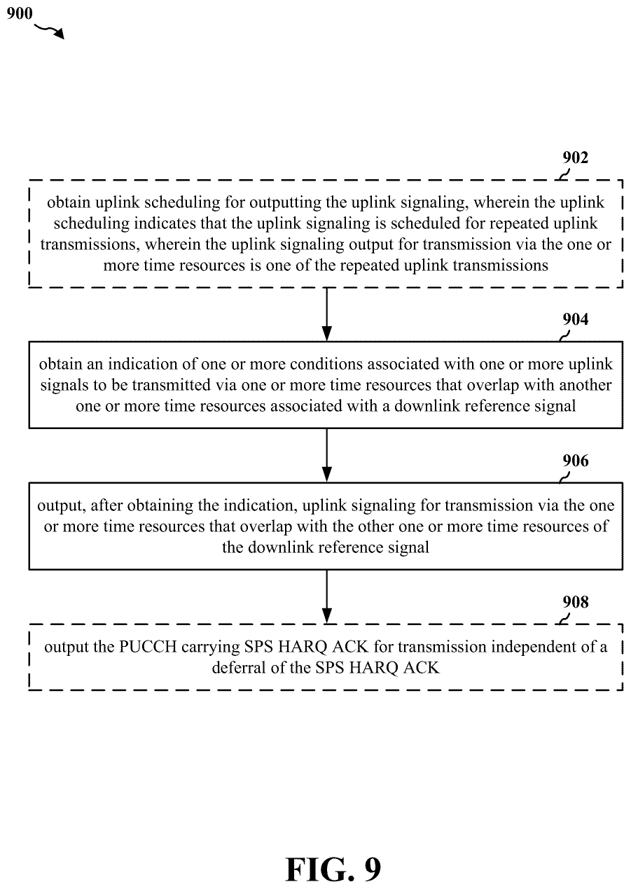

FIG. 9 is a flowchart 900 of a method of wireless communication. The method may be performed by a UE (e.g., the UE 104; the apparatus 1002). Specifically, the method may be performed by one or more processors (e.g., the controller(s)/processor(s) 359 in FIG. 3, the Tx processor 368 in FIG. 3, the Rx processor 356 in FIG. 3, etc.).

At 902, the UE may optionally obtain uplink scheduling for outputting the uplink signaling, wherein the uplink scheduling indicates that the uplink signaling is scheduled for repeated uplink transmissions, wherein the uplink signaling output for transmission via the one or more time resources is one of the repeated uplink transmissions. For example, 902 may be performed by an obtaining component 1040. Here, a base station may schedule the UE to make repeated transmissions of an uplink signal. If one or more of the repeated uplink transmissions is scheduled via time resources (e.g., symbols, slots, etc.) that overlap with time resources used for a downlink reference signal, then the UE may refrain from transmitting and/or transmit at a later time the one or more repeated uplink transmissions unless one or more conditions is met.

At 904, the UE may obtain an indication of one or more conditions associated with one or more uplink signals to be transmitted via one or more time resources that overlap with another one or more time resources associated with a downlink reference signal. For example, 904 may be performed by the obtaining component 1040. Here, a base station may transmit to the UE an indication of one or more conditions that, if met, would allow the UE to transmit an uplink signal using one or more time resources that overlap with one or more time resources used to transmit a downlink reference signal. Because the UE may be an SBFD-aware, half-duplex UE, the UE may be limited to either receiving the downlink reference signal or transmitting the uplink signal, but not both.

In certain aspects, the one or more conditions comprise the one or more time resources being available. For example, if a condition is met, the UE may transmit over time resources even if those time resources overlap with time resources used for downlink transmission.

In certain aspects, the one or more conditions comprise at least one of a network scheduling condition, a configuration condition, or a priority condition.

In certain aspects, the network scheduling condition is indicative of whether the uplink signaling is scheduled via a downlink control information (DCI) message or a radio resource control (RRC) message, and wherein the uplink signaling is output if the uplink signaling is scheduled via the DCI message.

In certain aspects, the configuration condition is indicative of whether the downlink reference signal is a first priority or a second priority, wherein the uplink signaling is output for transmission if the downlink reference signal is the first priority, and wherein the first priority is lower than the second priority.

In certain aspects, the priority condition is indicative of whether the uplink signaling is a first priority or a second priority, wherein the uplink signaling is output for transmission if the uplink signaling is the second priority, and wherein the first priority is lower than the second priority.

In certain aspects, the downlink reference signal comprises a synchronization signal block (SSB).

In certain aspects, the UE is subband full duplex (SBFD) aware and is configured for half-duplex communication.

At 906, the UE may output, after obtaining the indication, uplink signaling for transmission via the one or more time resources that overlap with the other one or more time resources of the downlink reference signal. For example, 906 may be performed by an outputting component 1042. Here, the UE may determine that a condition configured at the UE by the base station, is met. Thus, because the condition is met, the UE may transmit the uplink signal using time resource(s) that overlap with time resources used by the base station to transmit a downlink reference signal. As such, the UE does not have to refrain from transmitting uplink signals using the overlapping resources, reschedule the uplink transmission, or segment the uplink transmission.

In certain aspects, the uplink signaling is output for transmission via an uplink subband in a subband full duplex (SBFD) communication scheme.

In certain aspects, the uplink signaling is output for transmission via a symbol pattern, and wherein the one or more conditions is indicative of the symbol pattern being valid.

In certain aspects, the uplink signaling is output for transmission independent of segmenting the uplink signaling.

In certain aspects, the uplink signaling is output for transmission via a plurality of contiguous symbols.

In certain aspects, the uplink signaling comprises a physical uplink shared channel (PUSCH), a physical uplink control channel (PUCCH), or a PUCCH carrying semi-persistent scheduling (SPS) hybrid automatic repeat request (HARQ) acknowledgment (ACK).

In certain aspects, the downlink reference signal comprises at least one of a cell defining synchronization signal block (CD-SSB), a non-cell defining SSB (NCD-SSB), a measurement timing configuration SSB (MTC-SSB), a layer 1 (L1) SSB, a beam failure detection reference signal (BFD-RS), a radio link management RS (RLM-RS), or an SSB configured for radio resource management (RRM).

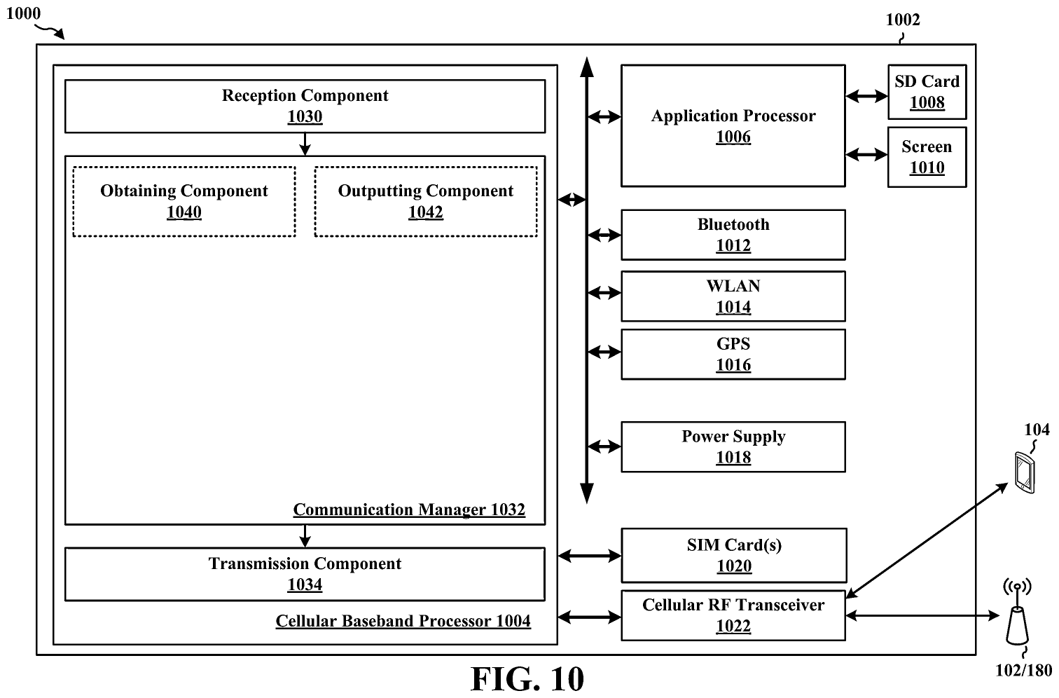

Finally, at 908, the UE may optionally output the PUCCH carrying SPS HARQ ACK for transmission independent of a deferral of the SPS HARQ ACK. For example, 908 may be performed by the outputting component 1042. Here, the UE may output the SPS HARQ ACK using time resources that overlap with time resources used by the base station to transmit a downlink reference signal instead of deferring the SPS HARQ ACK transmission to a future time resource. For example, if the SPS HARQ ACK was deferred to a future time resource, it would be done to allow the half-duplex UE to receive the downlink reference signal. However, if a condition is met, then the UE may transmit the uplink signal instead of receiving the downlink reference signal. FIG. 10 is a diagram 1000 illustrating an example of a hardware implementation for an apparatus 1002. The apparatus 1002 is a UE and includes a cellular baseband processor 1004 (also referred to as a modem) coupled to a cellular RF transceiver 1022 and one or more subscriber identity modules (SIM) cards 1020, an application processor 1006 coupled to a secure digital (SD) card 1008 and a screen 1010, a Bluetooth module 1012, a wireless local area network (WLAN) module 1014, a Global Positioning System (GPS) module 1016, and a power supply 1018. The cellular baseband processor 1004 communicates through the cellular RF transceiver 1022 with the UE 104 and/or BS 102/180. The cellular baseband processor 1004 may include a computer-readable medium/memory. The computer-readable medium/memory may be non-transitory. The cellular baseband processor 1004 is responsible for general processing, including the execution of software stored on the computer-readable medium/memory. The software, when executed by the cellular baseband processor 1004, causes the cellular baseband processor 1004 to perform the various functions described supra. The computer-readable medium/memory may also be used for storing data that is manipulated by the cellular baseband processor 1004 when executing software. The cellular baseband processor 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the cellular baseband processor 1004. The cellular baseband processor 1004 may be a component of the UE 104 and may include the memory 360 and/or at least one of the TX processor 368, the RX processor 356, and the controller/processor 359. In one configuration, the apparatus 1002 may be a modem chip and include just the baseband processor 1004, and in another configuration, the apparatus 1002 may be the entire UE (e.g., see UE 104 of FIG. 3) and include the aforediscussed additional modules of the apparatus 1002. In various examples, the apparatus 1002 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1032 includes an obtaining component 1040 configured to obtain uplink scheduling for outputting the uplink signaling, wherein the uplink scheduling indicates that the uplink signaling is scheduled for repeated uplink transmissions, wherein the uplink signaling output for transmission via the one or more time resources is one of the repeated uplink transmissions; and obtain an indication of one or more conditions associated with one or more uplink signals to be transmitted via one or more time resources that overlap with another one or more time resources associated with a downlink reference signal; e.g., as described in connection with 902 and 904 of FIG. 9.

The communication manager 1032 further includes an outputting component 1042 configured to output, after obtaining the indication, uplink signaling for transmission via the one or more time resources that overlap with the other one or more time resources of the downlink reference signal; and output the PUCCH carrying SPS HARQ ACK for transmission independent of a deferral of the SPS HARQ ACK; e.g., as described in connection with 906 and 908 of FIG. 9.

The apparatus may include additional components that perform each of the blocks of the algorithm in the aforementioned flowcharts of FIG. 9. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1002, and in particular the cellular baseband processor 1004, includes means for obtaining uplink scheduling for outputting the uplink signaling, wherein the uplink scheduling indicates that the uplink signaling is scheduled for repeated uplink transmissions, wherein the uplink signaling output for transmission via the one or more time resources is one of the repeated uplink transmissions; means for obtaining an indication of one or more conditions associated with one or more uplink signals to be transmitted via one or more time resources that overlap with another one or more time resources associated with a downlink reference signal; means for outputting, after obtaining the indication, uplink signaling for transmission via the one or more time resources that overlap with the other one or more time resources of the downlink reference signal; and means for outputting the PUCCH carrying SPS HARQ ACK for transmission independent of a deferral of the SPS HARQ ACK.

The aforementioned means may be one or more of the aforementioned components of the apparatus 1002 configured to perform the functions recited by the aforementioned means.

As described supra, the apparatus 1002 may include the TX Processor 368, the RX Processor 356, and the one or more controller(s)/processor(s) 359. As such, in one configuration, the aforementioned means may be the TX Processor 368, the RX Processor 356, and the one or more controller(s)/processor(s) 359 configured to perform the functions recited by the aforementioned means.

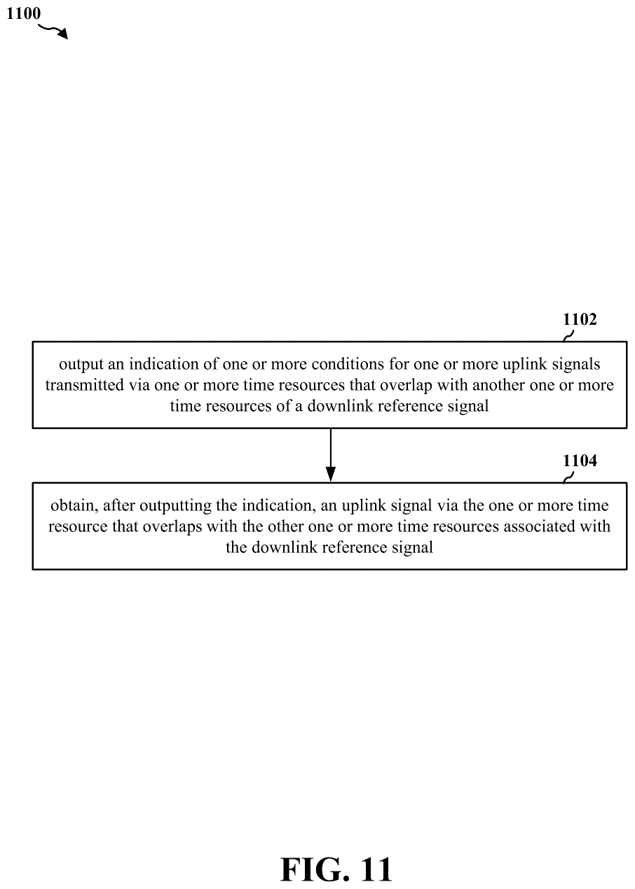

FIG. 11 is a flowchart 1100 of a method of wireless communication. The method may be performed by a base station (e.g., the base station 102/180; the apparatus 1202). Specifically, the method may be performed by one or more processors (e.g., the controller(s)/processor(s) 375 of FIG. 1 and any other suitable hardware illustrated in FIG. 1).

At 1102, the base station may output an indication of one or more conditions for one or more uplink signals transmitted via one or more time resources that overlap with another one or more time resources of a downlink reference signal. For example, 1102 may be performed by an outputting component 1240. Here, the base station may provide the UE with an indication of scenarios where the half-duplex, SBFD-aware UE may transmit an uplink signal using time resources that overlap with time resources used by the base station to transmit a downlink reference signal.

At 1104, the base station may obtain, after outputting the indication, an uplink signal via the one or more time resource that overlaps with the other one or more time resources associated with the downlink reference signal. For example, 1104 may be performed by an obtaining component 1242. Here, the base station may receive an uplink signal transmitted using time resources that overlap with time resources used by the base station to transmit a downlink reference signal. Thus, the UE may transmit the uplink signal in this manner based on the uplink signal or an aspect associated with the uplink signal satisfying a condition indicated by the base station.

In certain aspects, the one or more conditions for uplink signals comprise one or more of a network scheduling condition, a configuration condition, or a priority condition.

In certain aspects, the network scheduling condition is indicative of whether the uplink signaling is scheduled by the apparatus via a downlink control information (DCI) message or a radio resource control (RRC) message, and wherein the uplink signaling is obtained if the uplink signaling is scheduled via the DCI message.

In certain aspects, the configuration condition is indicative of whether the downlink reference signal is a first priority or a second priority, wherein the uplink signaling is obtained if the downlink reference signal is the first priority, and wherein the first priority is lower than the second priority.

In certain aspects, the priority condition is indicative of whether the uplink signaling is a first priority or a second priority, wherein the uplink signaling is obtained if the uplink signaling is the second priority, and wherein the first priority is lower than the second priority.

In certain aspects, the downlink reference signal comprises a synchronization signal block (SSB).

In certain aspects, the uplink signaling is obtained via an uplink subband in a subband full duplex (SBFD) communication scheme.

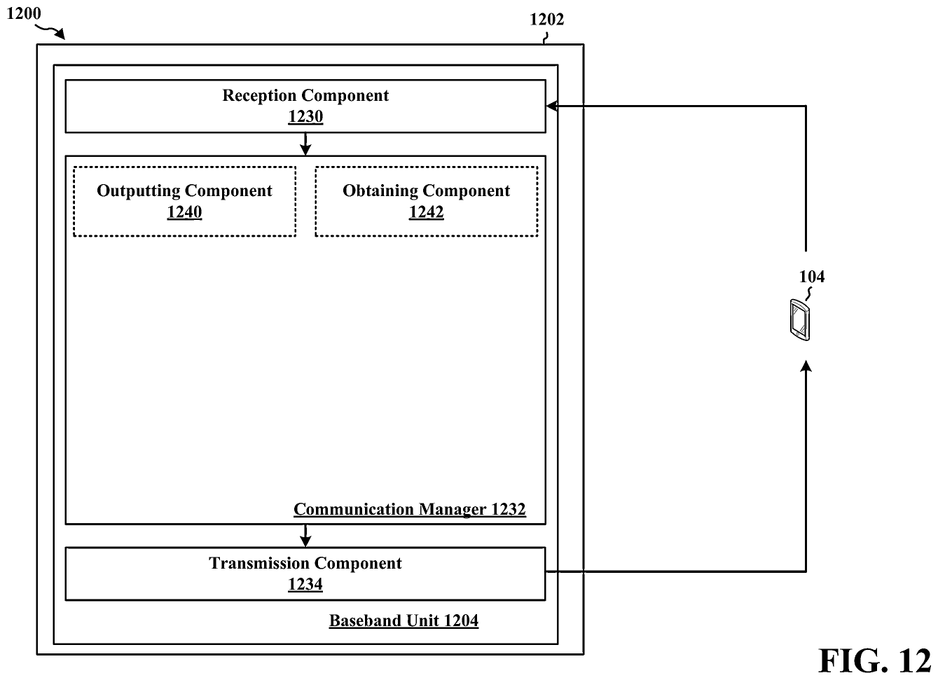

FIG. 12 is a diagram 1200 illustrating an example of a hardware implementation for an apparatus 1202. The apparatus 1202 is a BS and includes a baseband unit 1204. The baseband unit 1204 may communicate through a cellular RF transceiver with the UE 104. The baseband unit 1204 may include a computer-readable medium/memory. The baseband unit 1204 is responsible for general processing, including the execution of software stored on the computer-readable medium/memory. The software, when executed by the baseband unit 1204, causes the baseband unit 1204 to perform the various functions described supra. The computer-readable medium/memory may also be used for storing data that is manipulated by the baseband unit 1204 when executing software. The baseband unit 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the baseband unit 1204. The baseband unit 1204 may be a component of the BS 102/180 and may include the memory 376 and/or at least one of the TX processor 316, the RX processor 370, and the controller/processor 375. In various examples, the apparatus 1202 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1232 includes an outputting component 1240 configured to output an indication of one or more conditions for one or more uplink signals transmitted via one or more time resources that overlap with another one or more time resources of a downlink reference signal, e.g., as described in connection with 1102. The communication manager 1232 further includes an obtaining component 1242 configured to obtain, after outputting the indication, an uplink signal via the one or more time resource that overlaps with the other one or more time resources associated with the downlink reference signal, e.g., as described in connection with 1104.

The apparatus may include additional components that perform each of the blocks of the algorithm in the aforementioned flowchart of FIG. 11. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the baseband unit 1204, includes means for outputting an indication of one or more conditions for one or more uplink signals transmitted via one or more time resources that overlap with another one or more time resources of a downlink reference signal; and means for obtaining, after outputting the indication, an uplink signal via the one or more time resource that overlaps with the other one or more time resources associated with the downlink reference signal.

The aforementioned means may be one or more of the aforementioned components of the apparatus 1202 configured to perform the functions recited by the aforementioned means. As described supra, the apparatus 1202 may include the TX Processor 316, the RX Processor 370, and the one or more controller(s)/processor(s) 375. As such, in one configuration, the aforementioned means may be the TX Processor 316, the RX Processor 370, and the controller(s)/processor(s) 375 configured to perform the functions recited by the aforementioned means.

### Additional Considerations

Means for receiving or means for obtaining may include a receiver, such as the receive processor 356/370 and/or an antenna(s) 320/352 of the BS 102/180 and UE 104 illustrated in FIG. 3. Means for transmitting or means for outputting may include a transmitter, such as the transmit processor 316/368 and/or an antenna(s) 320/352 of the BS 102/180 and UE 104 illustrated in FIG. 3. Means for estimating, means for determining, means for measuring, and/or means for performing may include a processing system, which may include one or more processors, such as the controller(s)/processor(s) 375/359 of the BS 102/180 and the UE 104 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Aspects

The following examples are illustrative only and may be combined with aspects of other embodiments or teachings described herein, without limitation.

Example 1 is a method for wireless communication at a wireless node, comprising: obtaining an indication of one or more conditions associated with one or more uplink signals to be transmitted via one or more time resources that overlap with another one or more time resources associated with a downlink reference signal; and outputting, after obtaining the indication, uplink signaling for transmission via the one or more time resources that overlap with the other one or more time resources of the downlink reference signal.

Example 2 is the method of example 1, wherein the one or more conditions comprise the one or more time resources being available.

Example 3 is the method of any of examples 1 and 2, wherein the one or more conditions comprise at least one of a network scheduling condition, a configuration condition, or a priority condition.

Example 4 is the method of example 3, wherein the network scheduling condition is indicative of whether the uplink signaling is scheduled via a downlink control information (DCI) message or a radio resource control (RRC) message, and wherein the uplink signaling is output if the uplink signaling is scheduled via the DCI message.

Example 5 is the method of any of examples 3 and 4, wherein the configuration condition is indicative of whether the downlink reference signal is a first priority or a second priority, wherein the uplink signaling is output for transmission if the downlink reference signal is the first priority, and wherein the first priority is lower than the second priority.

Example 6 is the method of any of examples 3-5, wherein the priority condition is indicative of whether the uplink signaling is a first priority or a second priority, wherein the uplink signaling is output for transmission if the uplink signaling is the second priority, and wherein the first priority is lower than the second priority.

Example 7 is the method of any of examples 1-6, wherein the downlink reference signal comprises a synchronization signal block (SSB).

Example 8 is the method of any of examples 1-7, wherein the wireless node is subband full duplex (SBFD) aware and is configured for half-duplex communication.

Example 9 is the method of any of examples 1-8, wherein the uplink signaling is output for transmission via an uplink subband in a subband full duplex (SBFD) communication scheme.

Example 10 is the method of any of examples 1-9, wherein the method further comprises: obtaining uplink scheduling for outputting the uplink signaling, wherein the uplink scheduling indicates that the uplink signaling is scheduled for repeated uplink transmissions, wherein the uplink signaling output for transmission via the one or more time resources is one of the repeated uplink transmissions.

Example 11 is the method of any of examples 1-10, wherein the uplink signaling is output for transmission via a symbol pattern, and wherein the one or more conditions is indicative of the symbol pattern being valid.

Example 12 is the method of any of examples 1-11, wherein the uplink signaling is output for transmission independent of segmenting the uplink signaling.

Example 13 is the method of any of examples 1-12, wherein the uplink signaling is output for transmission via a plurality of contiguous symbols.

Example 14 is the method of any of any of examples 1-13, wherein the uplink signaling comprises a physical uplink shared channel (PUSCH), a physical uplink control channel (PUCCH), or a PUCCH carrying semi-persistent scheduling (SPS) hybrid automatic repeat request (HARQ) acknowledgment (ACK).

Example 15 is the method of example 14, wherein the method further comprises: outputting the PUCCH carrying SPS HARQ ACK for transmission independent of a deferral of the SPS HARQ ACK.

Example 16 is the method of any of examples 1-15, wherein the downlink reference signal comprises at least one of a cell defining synchronization signal block (CD-SSB), a non-cell defining SSB (NCD-SSB), a measurement timing configuration SSB (MTC-SSB), a layer 1 (L1) SSB, a beam failure detection reference signal (BFD-RS), a radio link management RS (RLM-RS), or an SSB configured for radio resource management (RRM).

Example 17 is a method for wireless communication at a wireless node, comprising: outputting an indication of one or more conditions for one or more uplink signals transmitted via one or more time resources that overlap with another one or more time resources of a downlink reference signal; and obtaining, after outputting the indication, an uplink signal via the one or more time resource that overlaps with the other one or more time resources associated with the downlink reference signal.

Example 18 is the method of example 17, wherein the one or more conditions for uplink signals comprise one or more of a network scheduling condition, a configuration condition, or a priority condition.

Example 19 is the method of example 18, wherein the network scheduling condition is indicative of whether the uplink signaling is scheduled by the wireless node via a downlink control information (DCI) message or a radio resource control (RRC) message, and wherein the uplink signaling is obtained if the uplink signaling is scheduled via the DCI message.

Example 20 is the method of any of examples 18 and 19, wherein the configuration condition is indicative of whether the downlink reference signal is a first priority or a second priority, wherein the uplink signaling is obtained if the downlink reference signal is the first priority, and wherein the first priority is lower than the second priority.

Example 21 is the method of any of examples 18-20, wherein the priority condition is indicative of whether the uplink signaling is a first priority or a second priority, wherein the uplink signaling is obtained if the uplink signaling is the second priority, and wherein the first priority is lower than the second priority.

Example 22 is the method of any of examples 17-21, wherein the downlink reference signal comprises a synchronization signal block (SSB).

Example 23 is the method of any of examples 17-22, wherein the uplink signaling is obtained via an uplink subband in a subband full duplex (SBFD) communication scheme.

Example 24 is an apparatus for wireless communications, comprising means for performing a method in accordance with any one of examples 1-16.

Example 25 is an apparatus for wireless communications, comprising means for performing a method in accordance with any one of examples 17-23.

Example 26 is a non-transitory computer-readable medium comprising instructions that, when executed by a wireless node, cause the wireless node to perform a method in accordance with any one of examples 1-16.

Example 27 is a non-transitory computer-readable medium comprising instructions that, when executed by a wireless node, cause the wireless node to perform a method in accordance with any one of examples 17-23.

Example 28 is an apparatus for wireless communications, comprising: one or more memories, individually or in combination, having instructions; and one or more processors, individually or in combination, configured to execute the instructions and cause the apparatus to perform a method in accordance with any one of examples 1-16.

Example 29 is an apparatus for wireless communications, comprising: one or more memories, individually or in combination, having instructions; and one or more processors, individually or in combination, configured to execute the instructions and cause the apparatus to perform a method in accordance with any one of examples 17-23.

Example 30 is a user equipment (UE), comprising: a transceiver; one or more memories, individually or in combination, having instructions; and one or more processors, individually or in combination, configured to execute the instructions and cause the UE to perform a method in accordance with any one of examples 1-16, wherein the transceiver is configured to: receive the indication of one or more conditions; and transmit the uplink signaling.

Example 31 is a network entity, comprising: a transceiver; one or more memories, individually or in combination, having instructions; and one or more processors, individually or in combination, configured to execute the instructions and cause the network entity to perform a method in accordance with any one of examples 17-23, wherein the transceiver is configured to: transmit the indication of one or more conditions; and receive the uplink signal.

What is claimed is:

1. An apparatus for wireless communication, comprising:
one or more memories, individually or in combination, having instructions; and
one or more processors, individually or in combination, configured to execute the instructions and cause the apparatus to:
obtain an indication of one or more conditions associated with one or more uplink signals to be transmitted via one or more time resources that overlap with another one or more time resources associated with a downlink reference signal; and
output, after obtaining the indication, uplink signaling for transmission via the one or more time resources that overlap with the other one or more time resources of the downlink reference signal.

2. The apparatus of claim 1, wherein the one or more conditions comprise the one or more time resources being available.

3. The apparatus of claim 1, wherein the one or more conditions comprise at least one of a network scheduling condition, a configuration condition, or a priority condition.

4. The apparatus of claim 3, wherein the network scheduling condition is indicative of whether the uplink signaling is scheduled via a downlink control information (DCI) message or a radio resource control (RRC) message, and wherein the uplink signaling is output if the uplink signaling is scheduled via the DCI message.

5. The apparatus of claim 3, wherein the configuration condition is indicative of whether the downlink reference signal is a first priority or a second priority, wherein the uplink signaling is output for transmission if the downlink reference signal is the first priority, and wherein the first priority is lower than the second priority.

6. The apparatus of claim 3, wherein the priority condition is indicative of whether the uplink signaling is a first priority or a second priority, wherein the uplink signaling is output for transmission if the uplink signaling is the second priority, and wherein the first priority is lower than the second priority.

7. The apparatus of claim 1, wherein the downlink reference signal comprises a synchronization signal block (SSB).

8. The apparatus of claim 1, wherein the apparatus is subband full duplex (SBFD) aware and is configured for half-duplex communication.

9. The apparatus of claim 1, wherein the uplink signaling is output for transmission via an uplink subband in a subband full duplex (SBFD) communication scheme.

10. The apparatus of claim 1, wherein the one or more processors, individually or in combination, are further configured to cause the apparatus to:
obtain uplink scheduling for outputting the uplink signaling, wherein the uplink scheduling indicates that the uplink signaling is scheduled for repeated uplink transmissions, wherein the uplink signaling output for transmission via the one or more time resources is one of the repeated uplink transmissions.

11. The apparatus of claim 1, wherein the uplink signaling is output for transmission via a symbol pattern, and wherein the one or more conditions is indicative of the symbol pattern being valid.

12. The apparatus of claim 1, wherein the uplink signaling is output for transmission independent of segmenting the uplink signaling.

13. The apparatus of claim 1, wherein the uplink signaling is output for transmission via a plurality of contiguous symbols.

14. The apparatus of claim 1, wherein the uplink signaling comprises a physical uplink shared channel (PUSCH), a physical uplink control channel (PUCCH), or a PUCCH carrying semi-persistent scheduling (SPS) hybrid automatic repeat request (HARQ) acknowledgment (ACK).

15. The apparatus of claim 14, wherein the uplink signaling comprises the PUCCH carrying the SPS HARQ ACK, and wherein the one or more processors are further configured to:
output the PUCCH carrying SPS HARQ ACK for transmission independent of a deferral of the SPS HARQ ACK.

16. The apparatus of claim 1, wherein the downlink reference signal comprises at least one of a cell defining synchronization signal block (CD-SSB), a non-cell defining SSB (NCD-SSB), a measurement timing configuration SSB (MTC-SSB), a layer 1 (L1) SSB, a beam failure detection reference signal (BFD-RS), a radio link management RS (RLM-RS), or an SSB configured for radio resource management (RRM).

17. The apparatus of claim 1, further comprising a transceiver configured to:
receive the indication of one or more conditions for one or more uplink signals; and
transmit the uplink signaling via the one or more time resources that overlaps with the other one or more time resources of the downlink reference signal, wherein the apparatus is configured as a user equipment (UE).

18. An apparatus for wireless communication, comprising:
one or more memories, individually or in combination, having instructions; and
one or more processors, individually or in combination, configured to execute the instructions and cause the apparatus to:
output an indication of one or more conditions for one or more uplink signals transmitted via one or more time resources that overlap with another one or more time resources of a downlink reference signal; and
obtain, after outputting the indication, an uplink signal via the one or more time resource that overlaps with the other one or more time resources associated with the downlink reference signal.

19. The apparatus of claim 18, wherein the one or more conditions for uplink signals comprise one or more of a network scheduling condition, a configuration condition, or a priority condition.

20. The apparatus of claim 19, wherein the network scheduling condition is indicative of whether the uplink signaling is scheduled by the apparatus via a downlink control information (DCI) message or a radio resource control (RRC) message, and wherein the uplink signaling is obtained if the uplink signaling is scheduled via the DCI message.

21. The apparatus of claim 19, wherein the configuration condition is indicative of whether the downlink reference signal is a first priority or a second priority, wherein the uplink signaling is obtained if the downlink reference signal is the first priority, and wherein the first priority is lower than the second priority.

22. The apparatus of claim 19, wherein the priority condition is indicative of whether the uplink signaling is a first priority or a second priority, wherein the uplink signaling is obtained if the uplink signaling is the second priority, and wherein the first priority is lower than the second priority.

23. The apparatus of claim 18, wherein the downlink reference signal comprises a synchronization signal block (SSB).

24. The apparatus of claim 18, wherein the uplink signaling is obtained via an uplink subband in a subband full duplex (SBFD) communication scheme.

25. The apparatus of claim 18, further comprising a transceiver configured to:
transmit the indication of one or more conditions for one or more uplink signals; and
receive the uplink signal via the one or more time resources that overlap with the other one or more time resources of the downlink reference signal, wherein the apparatus is configured as a network entity.
